(19) United States
(12) Patent Application Publication
(10) Pub. No.: US 2008/0195477 A1
(43) Pub. Date: Aug. 14, 2008

(54) Method and system for advertising locally relevant content through a computer network

(76) Inventors: J. Matthew Kennedy, Pownal, ME (US); James Boutin, Yarmouth, ME (US); Robert Richards, Limington, ME (US)

Correspondence Address: KEVIN FARRELL;PIERCE ATWOOD, ONE NEW HAMPSHIRE AVENUE, PORTSMOUTH, NH, 03801, US

(21) Appl. No.: 11/706,748

(22) Filed: Feb. 14, 2007

(51) Int. Cl. G06Q 30/00

(52) U.S. Cl. 705/14

(57) ABSTRACT

In one embodiment, the present invention comprises a computer-implemented method for creating and managing locally relevant dynamic content for a regional, national or international organization and for selectively displaying the locally relevant information in response to a request from a user terminal connected to a computer network. The method comprises providing an organization terminal connected to the computer network wherein the organization terminal contains therein a software portion executable by a processor. The organization terminal receives a request from a user terminal, and, in response, executes the software portion. The organization terminal thus populates at least one hard coded template on a graphical user interface with one or more product object identifiers (POIDS) and any optional design elements within one or more defined control zones and according to at least one campaign rule. This thereby creates a single point deployment of locally relevant information at the user terminal.

### BACKGROUND OF THE INVENTION

1. Field of the Invention

The present invention relates generally to the field of distributing locally relevant information through a computer network and more particularly, this invention relates to distributing locally relevant and corporately branded content that is directly responsive to specific requests.

2. Discussion of Background Information

Nationally branded retailers place a premium on consistently presenting their brand, their merchandising and all of their advertising messages and marketing campaigns. Currently these retailers, however, employ cumbersome methods for using computer networks, and specifically the World Wide Web (WWW), to localize their marketing messages to marketing audiences within particular geographic locations or regions.

Most multi-location retailers' websites reference a local store only in conjunction with a rudimentary “store finder” functionality. These store finder functions typically receive geographic data inputs such as an address, city, state, zip code, and preferred distance, and based on this data, the function produces static information regarding a nearby location or list of locations matching a user's input criteria. The store finder function also may provide some useful information associated with these highlighted locations, but that information generally comprises an address, phone number, store hours and, in the best-case scenarios, a high-level list of services available at a location. This latter feature exists only if services vary from location to location within a retailer's array of stores, and even if these service lists do exist for a particular location, such a limited set of data is likely of little use or interest to a consumer.

These rudimentary store finder pages fail to function as destinations, or “landing pages,” that present specific, localized marketing campaigns for a larger retail organization. A retailer thus has a limited ability to market to consumers based on geographic differentiations. For example, winter in the Northeast region of the United States is climatically different from winter in the Southwest region, and these different conditions require very different marketing messages in each of those regions during winter months.

In addition to failing to employ marketing campaigns that addresses key regional or local conditions, the rudimentary store finder functions lack any ability to leverage local personnel in developing content or messaging to their local audience. Such local personnel understand their local audience better than a centralized, national marketing entity could. These local personnel are an unused resource in tailoring local marketing messages.

The net result of these inadequacies in existing systems and methods is a loss of localized relevance for national retailers. National retailers face a growing challenge in that consumers in local municipalities perceive national retailers as “outsiders” from whom they are less likely to make purchases than from local organizations that inherently tailor their traditional and online marketing campaigns to address local needs.

For these reasons, a need exists for a manageable and operationally efficient system and method with which large organizations may create rich marketing website content and localize the conditions under which consumers receive that content.

### SUMMARY OF THE INVENTION

The present invention is directed to a system and method for creating a permissions-based platform for campaign and content management that results in a store-based landing page combining critical operational data with rich content describing specific offers and services for that particular store. The content appearing on a localized landing page is constructed dynamically as determined by the method through which the consumer has “landed” on the page. These methods may include search engines, emails, or webpage banner advertisements, for example.

In one embodiment, the present invention comprises a computer-implemented method for creating and managing locally relevant dynamic content for a regional, national or international organization and for selectively displaying the locally relevant information in response to a request from a user terminal connected to a computer network. The method comprises providing an organization terminal connected to the computer network wherein the organization terminal comprises a memory portion and a processor portion and wherein the memory portion contains therein a software portion executable by the processor. The memory portion further comprises a rule defining geographical boundaries within which to establish locally relevant dynamic content and one or more product object identifiers (POIDs) associated with the defined geographical boundaries.

The memory portion also comprises defined control zones for placing the one or more POIDs within a graphical user interface for display at the user terminal. At least one hard coded template exists in the memory portion for placing the defined control zones and optional design elements on the graphical user interface; and one or more campaigns exist wherein each campaign has one or more associated campaign rules governing population of the hard coded template in response to the request. The organization terminal then receives the request from the user terminal which is also connected to the computer network. In response to receiving that request, the organization terminal executes the software portion and populates the at least one hard coded template with the one or more POIDs and the optional design elements within the defined control zones and according to the at least one campaign rule thereby creating a single point deployment of locally-relevant information at the user terminal.

In one embodiment, the user terminal's request for specific local content may comprise key search terms. The organization terminal receives those requests, identifies at least one locally relevant campaign having key search terms that match the request's key search terms, and retrieves the at least one locally relevant campaign from a database server. The organization terminal then displays at the user terminal a link for automatically redirecting the user terminal to the at least one locally relevant campaign. In this embodiment, the key search terms remain in the dynamic website's address bar and determine content for display.

### BRIEF DESCRIPTION OF THE DRAWINGS

FIG. 1a is a schematic showing an overview of an embodiment of the system of the present invention.

FIG. 2 is a schematic showing an embodiment of the method of the present invention.

FIG. 3 is a schematic showing an overview of an embodiment of the system of the present invention.

FIG. 3a is an exemplary embodiment of a graphical user interface representing one aspect of an embodiment of the present invention.

FIG. 3b is an exemplary embodiment of a graphical user interface representing another aspect of the present invention.

FIG. 3c is an exemplary embodiment of a graphical user interface representing yet another aspect of the present invention.

FIG. 3c is an exemplary embodiment of a graphical user interface representing still yet another aspect of the present invention.

FIG. 3e. is a schematic of an embodiment of another aspect of the system of the present invention.

FIG. 4a is an exemplary embodiment of a graphical user interface representing one aspect of an embodiment of the present invention.

FIG. 4b is a depiction of an exemplary embodiment of a graphical user interface representing an aspect of the present invention.

FIG. 5a is a depiction of an exemplary embodiment of a graphical user interface representing an aspect of the present invention.

FIG. 5b is a depiction of an exemplary embodiment of a graphical user interface representing an aspect of the present invention.

FIG. 6a is a depiction of an exemplary embodiment of a graphical user interface representing another aspect of the present invention.

FIG. 6b is a depiction of an exemplary embodiment of a graphical user interface representing yet another aspect of the present invention.

FIG. 7 is a depiction of an exemplary embodiment of a graphical user interface representing still another aspect of the present invention.

### DETAILED DESCRIPTION

The present invention resolves the stated deficiencies of typical landing page systems and methods, and provides a permissions-based platform for campaign and content management. The present invention produces a store-based landing page combining critical operational data with rich content describing specific offers, events and services for a specific store location or group of store locations. The selective content appearing on a localized landing page appears under dynamic conditions reflecting the method through which a consumer has “landed” on the page.

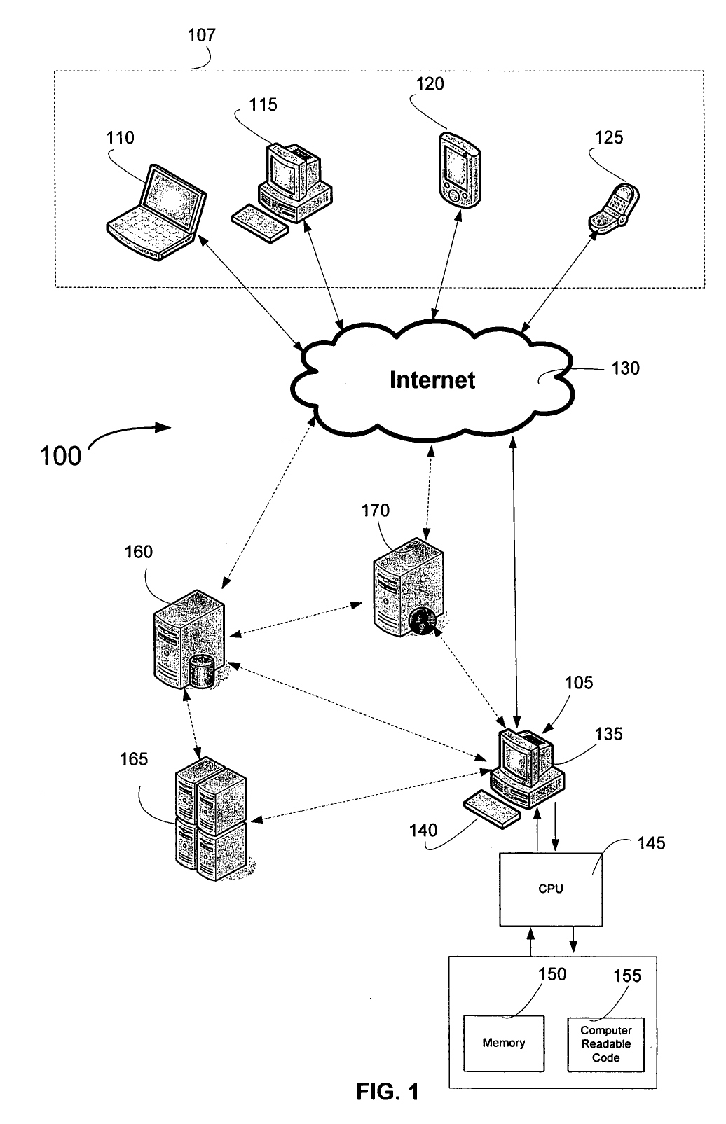

FIG. 1 depicts an overview of the landing page system 100 of the present invention. This system includes an organization terminal 105 in communication with a plurality of user terminals 107 that are communicating through a computer network. Because the present invention is available on a global level, and because the Internet 130 is a global electronic communications network linking private and public networks and computers, the Internet 130 is an appropriate medium for facilitating the present invention. The plurality of user terminals 107 are preferably devices capable of communicating with the Internet 130 through wired or wireless means, devices for example such as a laptop computer 110, a stationary computer 115, a personal computing device (PCD) 120, and a cellular telephone 125.

The organization terminal 105 is preferably a computer that comprises elements typical of a computing system. These elements include items such as a monitor 135, a keyboard 140, a processor such as a central processing unit (CPU) 145, and a memory storage area 150. The memory storage area 150 may be random access memory (RAM), or a combination of RAM and some removable memory storage means such as floppy disk, EPROMs, PROMs, or USB storage devices. The memory storage area 150 contains computer readable code, or software 155, for executing the present invention. In an alternative embodiment, the memory storage area 150 may be a database server 160 for an added level of security and more expansive storage capacity. In an alternative embodiment, the organization terminal 105 optionally also may communicate with an application server 165 that stores and executes the software 155 and with a web server 170 that hosts an interactive website that dynamically displays locally relevant information.

Bi-directional routers (not shown) also may be disposed between each of the plurality of user terminals 107 and the Internet 130, and between the Internet 130 and the organization terminal 105. Additionally the laptop computer 110, stationary computer 115, PCD 120, and cellular telephone 125 are shown by way of example only and an unlimited number of user terminals 107 may communicate with the organization terminal 105.

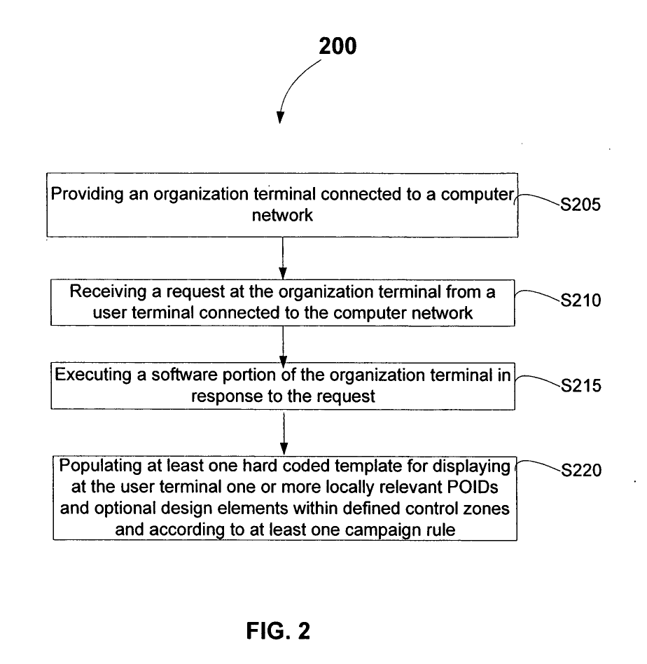

Turning now to FIG. 2, which depicts one embodiment of the method 200 of the present invention, a first step S205 to providing a dynamic local landing page comprises providing the organization terminal 105. A second step S210 comprises receiving a request at the organization terminal 105 from a user terminal 107 wherein both the organization terminal 105 and the user terminal 107 are connected to a computer network such as the Internet 130. A third step S215 comprises executing the software 155 at the organization terminal 105 in response to the request form the user terminal 107. Finally, a fourth step S220 in the process comprises populating a display at the user terminal 107 with locally relevant content. The following description addresses these method steps S205-S220 in detail and in reference to additional, descriptive figures.

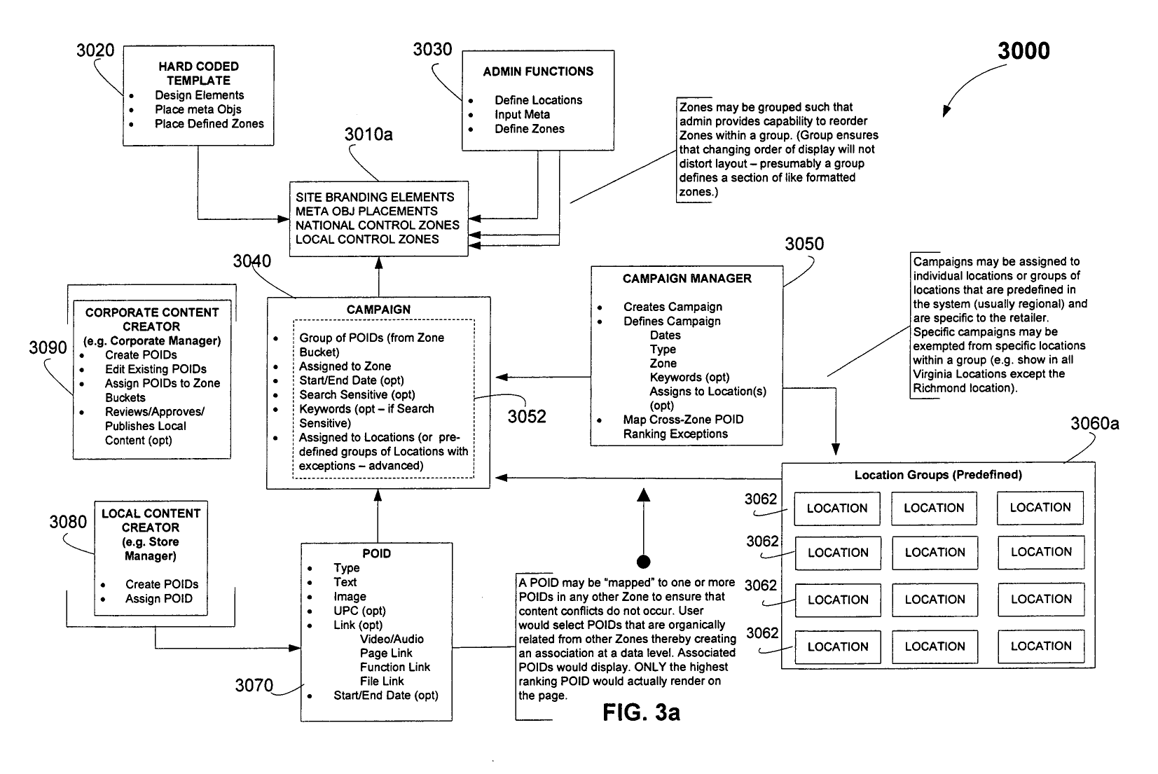

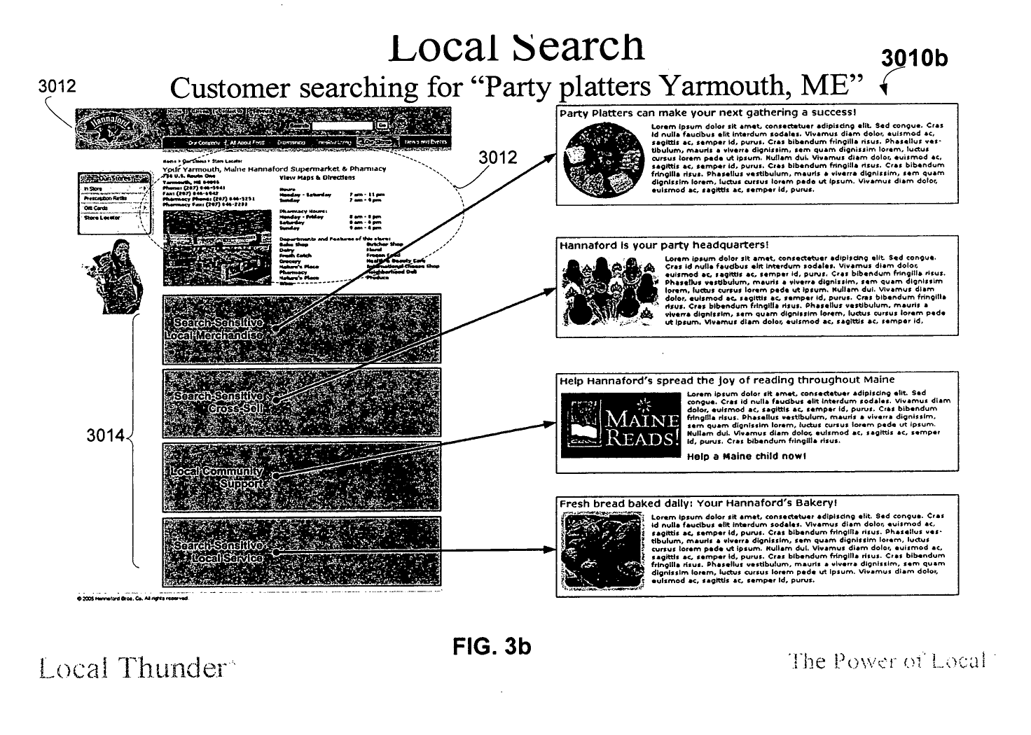

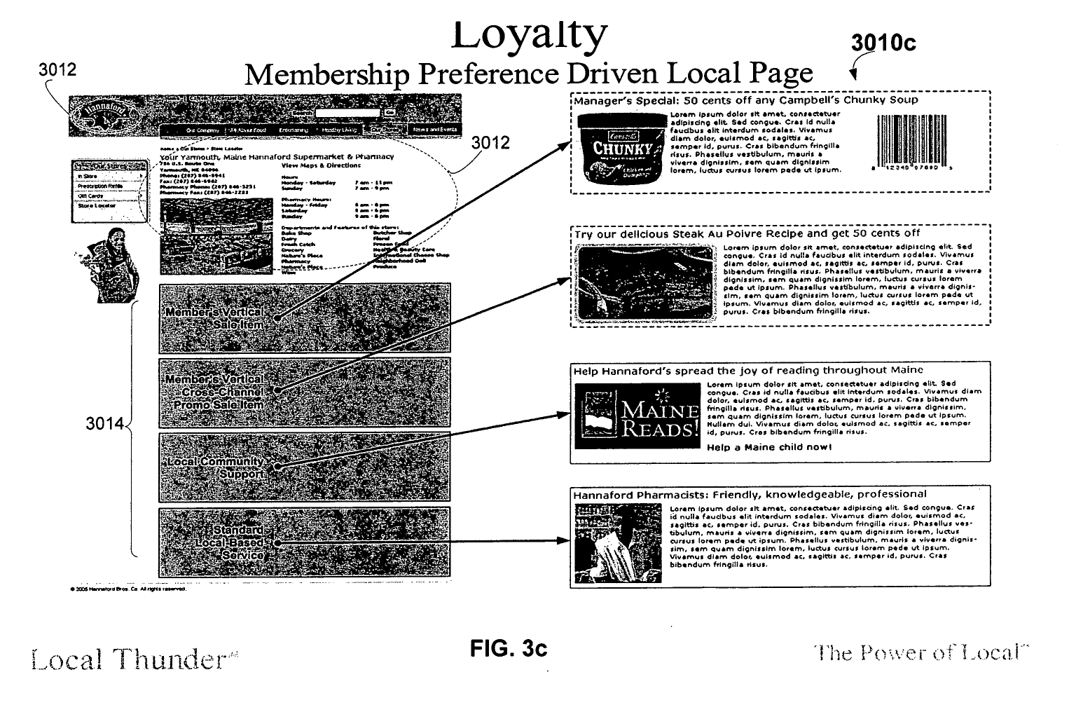

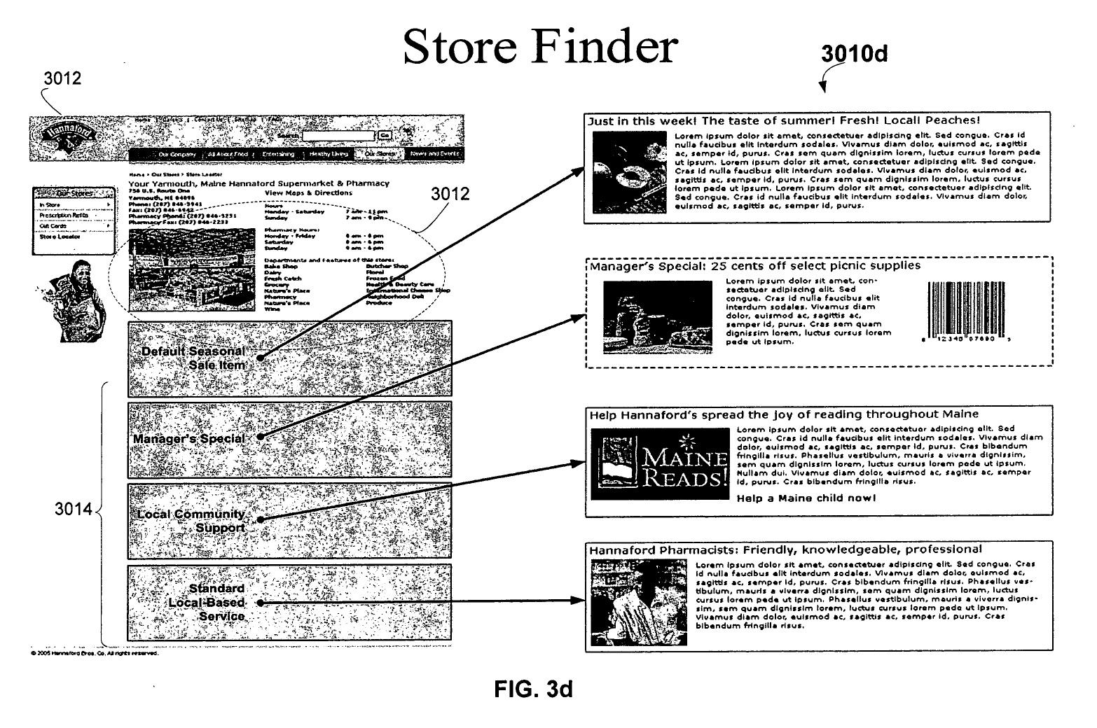

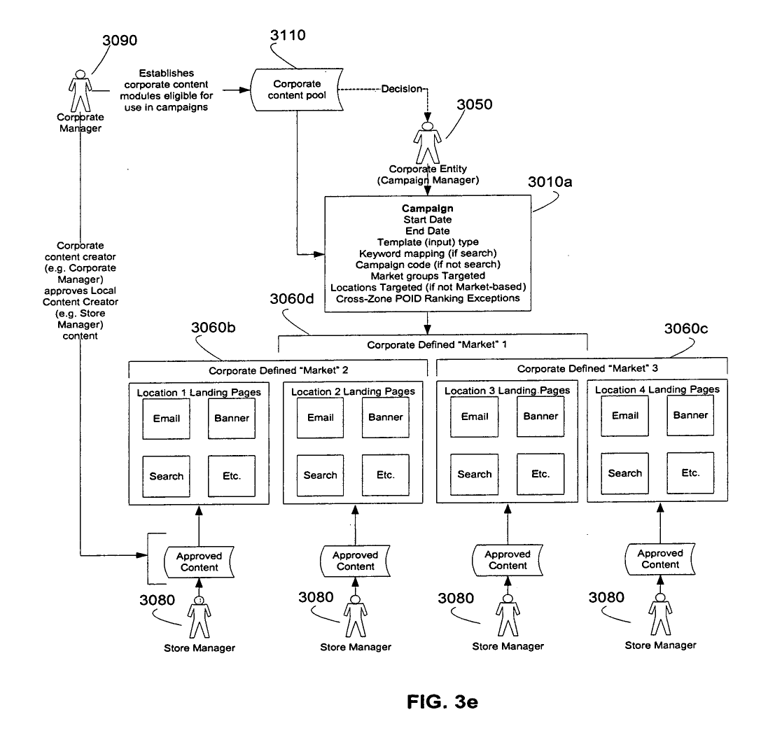

FIG. 3a is a schematic of an aspect of one embodiment of the system 3000 of the present invention that depicts basic data components and their rules and roles in creating a dynamic landing page 3010a. FIGS. 3b, 3c and 3d represent exemplary embodiments of graphical user interfaces depicting dynamic landing pages 3010b, 3010c, 3010d bearing locally relevant data as identified and selectively presented by embodiments of the system 3000 and method 200 of the present invention. Like numerals on each of these figures indicate corresponding elements.

As shown in FIG. 3a, the nexus of this system 3000 is a dynamic landing page 3010a constructed from several inputs. In one embodiment of the present invention, the building blocks for a dynamic landing page 3010a comprise one or more hard coded templates 3020, a set of administrator functions 3030 and one or more campaigns 3040. The landing page 3010a comprises optional design elements 3012, such as site branding elements and location information, and one or more control zones 3014 for selectively displaying national, regional and local content.

Taking each of these elements in detail, in a preferred embodiment, the present invention comprises at least one hard coded template 3020 and preferably comprises an array of hard coded templates 3020 from which the organization terminal 105 may choose when dynamically placing selective content on the landing page 3010a. The hard coded template 3020 for building the dynamic landing page 3010a provides designated areas within which to display the optional design elements 3012 and the one or more defined control zones 3014. The set of administrator functions 3030 include defining one or more store locations 3062 within a regional, national or international organization, defining optional design elements 3012, and defining the one or more control zones 3014. As shown in FIG. 3e, the set of administrator functions 3030 also may include defining one or more geographical boundaries, or markets 3060a, comprising a location 3062 or groups of locations 3060a with which to associate locally relevant content for selective display at a user terminal 107.

The exemplary landing pages 3010b, 3010c, and 3010d of FIGS. 3b, 3c and 3d each contain these recognizable components as they appear within a dynamically built landing page 3010a for a Yarmouth, Me. store. The store in this example belongs to a large, chain grocery retailer having store locations 3062 within several specific geographic boundaries 3060a representing distinct markets 3060b, 3060c, 3060d, as depicted in FIG. 3e. The optional design elements 3012 here include a recognizable brand icon and name, and static data, such as an address, hours, departments, and links to maps and directions for a particular store location 3062.

In accordance with a hard coded template 3020, one or more control zones 3014 dynamically populate a landing page 3010b, 3010c, 3010d depending on the method by which a user terminal 107 requests this local data. For example, a customer at a user terminal 107 employing a search engine to search for a particular item in a particular location 3062 or within a particular locally relevant market 3060b, 3060c, 3060d may trigger the present invention to display the control zones 3014 of FIG. 3b on the graphical user interface of their user terminal 107. These control zones 3014 may include, for example, search-sensitive local merchandise and search-sensitive cross-sell items for a store located in a specified town. Additional control zones 3014 may allow an organization to advertise local community activities and other useful local content.

A customer at a user terminal 107 who follows a URL link delivered in a targeted mailing or Email alert may prompt the landing page 3010c to display the control zones 3014 of FIG. 3c. One or more of these defined control zones 3014 pertain specifically to that particular user, who may be a member recognized for loyalty. Those control zones 3014 may include, for example, that particular member's vertical sale item, which may be a coupon for product that the member frequently purchases. Another zone may include other promotional sales items specifically targeted to the same repeat customer.

A customer at a user terminal 107 employing a store finder search mechanism may trigger the present invention to produce the control zones 3014 of FIG. 3d. These control zones 3014 may include for example, a control zone 3014 containing a default seasonal sale item and a control zone 3014 for marketing a manager's special. Again, this landing page 3010d also may comprise control zones 3014 relevant to a particular store location 3062. Here, the control zones 3014 include a seasonal sales item, a manager's special, information and links to information about a local community activity, and information about local-based services. These landing pages 3060a are thus flexible for featuring information specific to an individual location 3062. The individual locations 3062 thus can market and promote not only products within the control zones 3014, but the control zones 3014 are available for marketing other local store events or programs as well. These marketed items may include but are not limited to seasonal specials, recipe of the day, local growers promotions, local events promotions, in-store services, store manager specials, new product launches, community outreach and coupons.

In an embodiment including more than one control zone 3014, the administrator functions 3030 may include grouping the control zones 3014 according to similar formats so that changing the order of display on the hard coded template 3020 leaves layout undistorted. The one or more control zones 3014 may have dedicated associations with the one or more locally relevant markets 3060b, 3060c, 3060d. Alternatively, the one or more control zones 3014 may pertain to an organization as a whole. In yet another embodiment of the present invention, the defined control zones 3014 populating the dynamic landing page 3010a may comprise at least one defined control zone 3014 associated with a locally relevant market 3060b, 3060c, 3060d and at least one defined control zone 3014 associated with the organization as a whole.

In addition to receiving inputs from the hard coded template 3020 and the administrator functions 3030, the dynamic landing page 3010a receives inputs from one or more campaigns 3040 managed by at least one campaign manager 3050. Each campaign 3040 comprises dynamic variables, or conditions, that determine which marketing messages to display on a landing page 3010a. These campaigns 3040 form dynamically and formation depends on the method by which a user terminal 107 accesses a landing page 3010a generated by the organization terminal 105. These methods may include but are not limited to keyword parsing by a referring search engine, accessing a get link, and selecting a banner advertisement.

The campaign manager 3050 creates one or more campaign rules 3052 for each of the one or more campaigns 3040 that govern the dynamic creation of a landing page 3010a. The one or more campaign rules 3052 may include, for example, a defined start date and a defined end date for each campaign 3040. The campaign rules 3052 also may include assigning each campaign 3040 to a hard coded template 3020. The campaign rules 3052 also selectively assign each of the one or more campaigns 3040 to at least one location 3062. The campaign manager 3050 also may assign each campaign 3040 to one or more pre-defined groups of locations 3060a and further may exempt from that assignment one or more locations 3062 within the predefined groups of locations 3060a. For example, the campaign manager 3050 may assign a campaign 3040 to all Virginia locations of an organization with the exception of the Richmond, Va. location. The campaign manager 3050 may further establish one or more campaign rules 3052 for associating each campaign 3040 with the one or more defined control zones 3014. The campaign manager 3050 also may assign one or more product object identifiers (POIDS) 3070 within an associated control zone 3014 to one or more associated campaigns 3040, thereby associating the one or more POIDs 3070 with defined groups of locations 3060a to which those campaigns 3040 are assigned.

POIDs 3070 are marketing elements representing, for example, products, offers, services or events associated with one or more locations 3062, defined groups of locations 3060a, or markets 3060b, 3060c, 3060d. Each POID 3070 optionally may associate with more than one control zone 3014 and optionally may associate with one or more campaigns 3040. A POID 3070 may comprise any combination of elements, such as but not limited to, text, image, universal product code (UPC), and embedded link. Embedded links may deliver at a user terminal 107 any number of available communications items, including but not limited to a portable file, multimedia file, page link, function link or file link. In one embodiment, the method of the present invention further comprises defining a type for each of the one or more POIDs 3070, where a type represents, for example, a product, an offer, an event, or a service. The method further optionally provides establishing a start date and an end date for displaying each of the one or more POIDs 3070.

The campaign manager 3050 may map ranking exceptions for selectively assigned POIDs 3070 so that only a highest-ranking POID 3070 renders in a defined control zone 3014 on a graphical user interface at a user terminal. Additionally, the campaign manager 3050 may create one or more campaign rules 3052 that optionally link one or more POIDs 3070 that are selectively assigned to a defined control zone 3014 to one or more POIDs 3070 that are selectively assigned to any other defined control zone 3014. This thereby creates an association at a data level for simultaneously displaying linked POIDs 3070. In addition to linking POIDs 3070 so that they appear simultaneously, the campaign manager 3050 optionally may map one or more selectively assigned POIDs 3070 in a first defined control zone 3014 to one or more POIDs 3070 in any other control zone 3014 so that the linked POIDs 3070 appear only separately, thereby preventing conflicts.

In one embodiment of the present invention, one or more local content creators 3080 create one or more POIDs 3070 and assign each of those POIDs 3070 to the one or more defined control zones 3014. Additionally, one or more corporate content creators 3090 also may create one or more POIDs 3070 and assign each of those POIDs 3070 to the one or more defined control zones 3014. The one or more control zones 3014 in turn associate with one or more campaigns 3040 as defined by the campaign manager 3050. POIDs 3070 thus exist within one or more campaigns 3040 and comprise unique start and end days additional to a campaign's 3040 start and end dates, thereby creating dynamic, multi-tiered campaigns 3040 where contents, or POIDs 3070, appear and disappear based on point-in-time rules. POIDs 3070 also may comprise content rules that are defined by local content creators 3080 to include local notions of couponing that support externally generated UPCs, that upload externally generated portable file types, for example graphics, PDFs, and gifs, and that upload multimedia formats, for example audio, video, and flash. The method and system of the present invention are flexible for use with presenting any conceivable file type on a user interface at a user terminal 107.

Turning now to FIG. 3e, the method by which local content creators 3080 and corporate content creators 3090 interact to create and assign POIDs 3070 may include, in one embodiment, assimilating inputs from one or more local content creators 3080 and one or more corporate managers 3090 at the higher, organizational level. The one or more local content creators 3080 may be, for example, store managers at particular locations 3062. In an alternative embodiment, the corporate content creator 3090 and the campaign manager 3050 may be a single entity. In yet another embodiment, the local content creator 3080, the campaign manager 3050, and the local content creator 3080 may be a single entity. In a preferred embodiment though, one or more local content creators 3080 exist at a one or more locations 3062 and at least one corporate content creator 3090 exists at an organizational level.

In this embodiment, the corporate manager 3090 not only creates POIDs 3070 and assigns them to defined control zones 3014 or groups of defined control zones 3014, but the corporate manager 3090 also edits existing POIDs 3070 and optionally reviews, approves and publishes POIDs 3070 created and assigned by the one or more local content creators 3080. All approved POIDs 3070 exist in a corporate content pool 3110 for use in one or more campaigns 3040. Like the one or more campaigns 3040, the corporate content pool 3110 may exist within the database server 160 for storage and protection. Because the local content creator 3080 can contribute to the corporate content pool 3110, POIDs 3070 can exist that address needs and attitudes of a local market as understood best by a local content creator 3080. Because this embodiment of the method of the present invention involves a corporate approval step, the organization may maintain a certain level of control and consistency in their campaigns 3040. This system and method thus leverages knowledge by local personnel in developing the content pool 3110 and creating locally relevant content for display on a dynamic landing page 3010a.

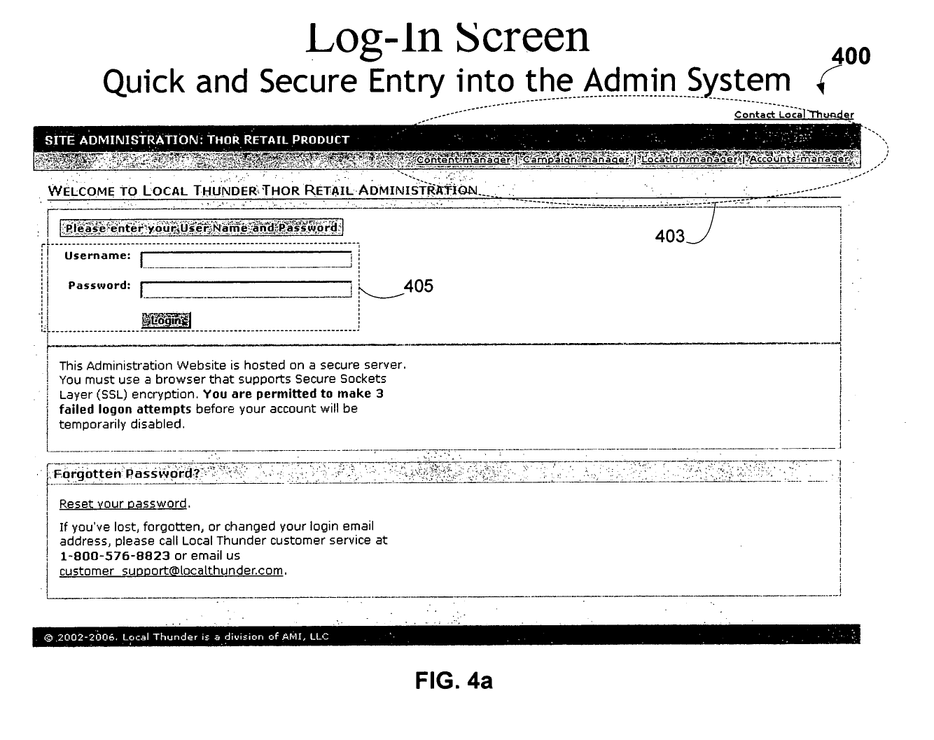

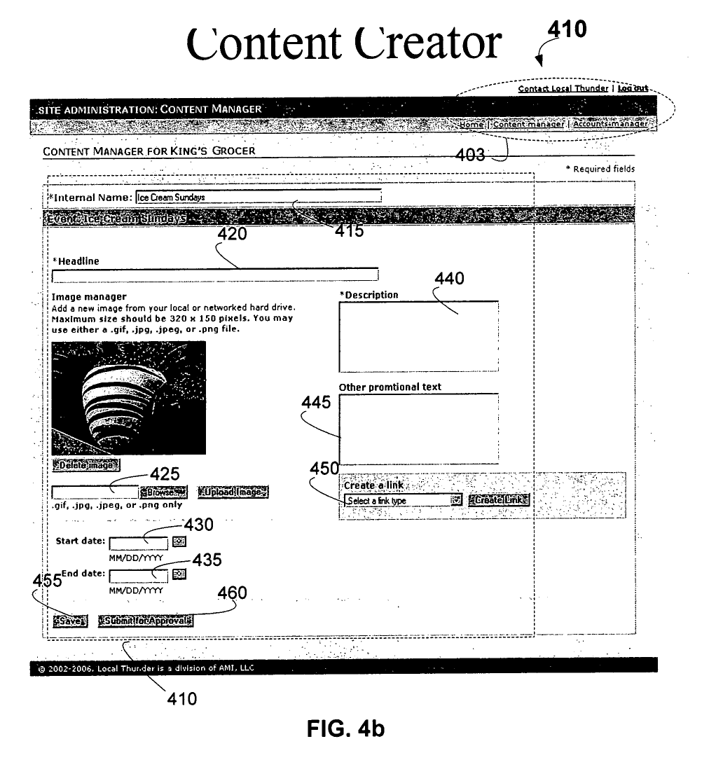

The system and method of the present invention thus facilitate content creation, review, editing and approval. As depicted in FIG. 3e and FIGS. 4a and 4b, the local content creator 3080, here a store manager, and the corporate content creator 3090, here a corporate manager, may log into the organization terminal 105 to create and assign content. FIG. 4a depicts an exemplary log-in screen 400 for accessing the content pool 3110 to review and edit existing POIDs 3070 and for creating and editing new POIDs 3070. Here, a local content creator 3080 or corporate content creator 3090 enters a secure administration website preferably presented by the web server 170, which action may require, for example, entering a unique username and password into one or more login fields 405. The log-in screen 400 may comprise elements typical of a webpage, including a top-level menu 403 for easy navigation.

Once logged in, a local content creator 3080 or corporate content creator 3090 may create content at a content creator page 410 that links with the log-in screen 400. The content creator page 410 may include one or more entry fields 410 for defining content and parameters for displaying POIDs 3070. For example, these login entry fields 410 may comprise an internal name field 415 and a headline 420 for external display. The entry fields 410 of the content creator page 410 also may include an image field 425 for uploading an image having a specified file extension format including but not limited to .gif, .jpg, .jpeg, or .png. Additionally, a local content creator 3080 or corporate content creator 3090 may enter a start date and an end date for a POID 3070 using a respective POID start date field 430 and a POID end date field 435. This content creator page 410 also may provide a description field 440 and an optional promotional text field 445. A link creation field 450 allows for linking content with additional elements for display, like multimedia files or external UPC codes, for example.

Certain entry fields 410 may required population, and may indicate such with, for example, an inconspicuous asterisk. For example, as depicted in FIG. 4b, the internal name field 415, headline field 420, and description field 440 may be required while other entry fields 410 remain optional. Any conceivable entry fields 410 may operate in conjunction with the content creator page 410 for developing and adding POIDs 3070 to the content pool 3110, and the content creator page 410 is expandable to include additional entry fields 410. When all required entry fields 410 are populated, a local content creator 3080 or corporate content creator 3090 respectively submits content for approval or saves content by selecting either a save button 455 or a submit for approval button 460.

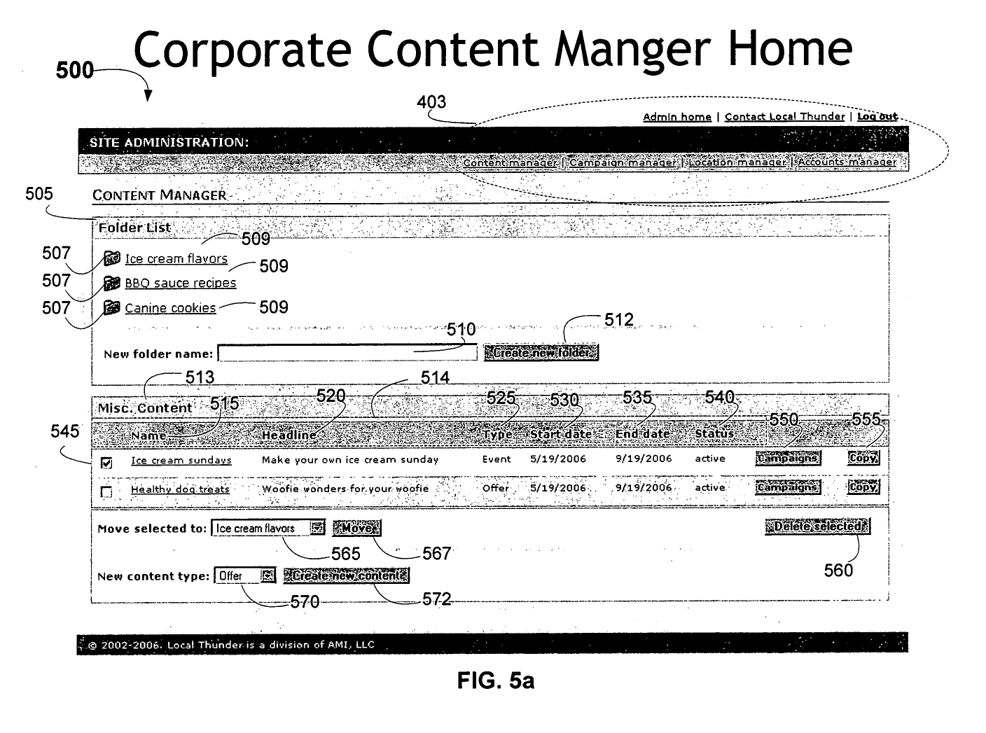

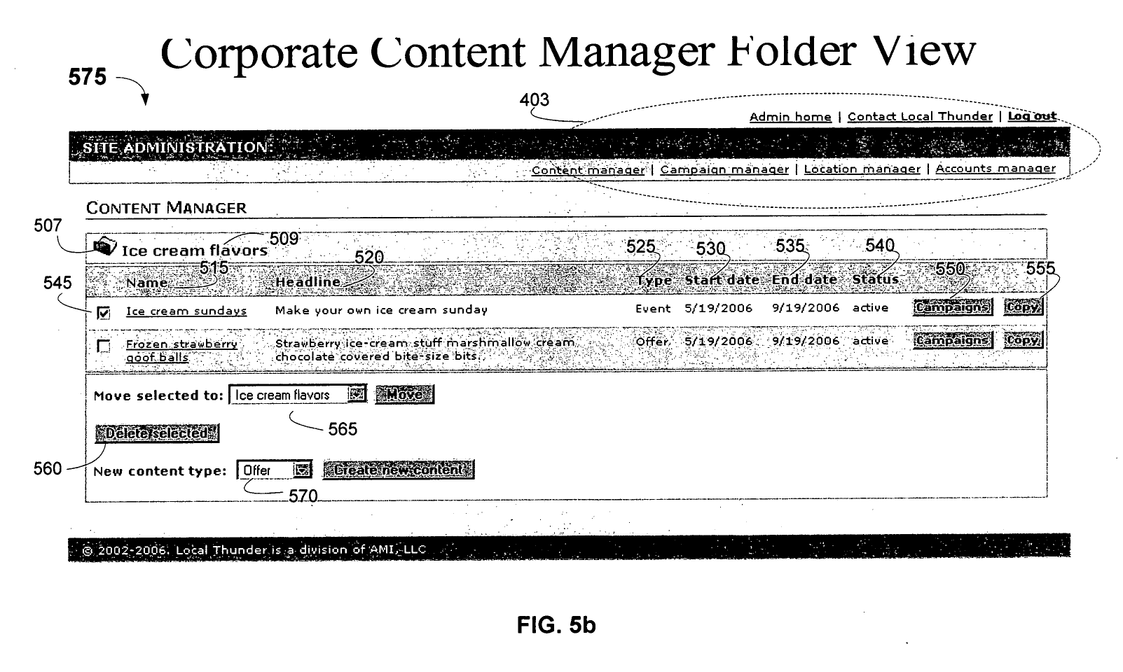

The present invention allows for further administration of the content pool 3110 by the corporate content creator 3090, depicted in FIG. 3e as the corporate manager. FIGS. 5a and 5b depict exemplary embodiments of a corporate content manager home page 500 and a corporate content manager folder view page 575, which provides additional administrative tools. The corporate content manager home page 500 and corporate content manager folder view page 575 are shown by way of example only and both are expandable and adaptable to suit an organization's specific needs. In the embodiment of FIG. 5a, the corporate content manager home page 500 provides enables management of the content pool 3110 within a control zone folder list 505 comprised of control zone folders 507 that categorize related content items, or POIDs 3070. In the embodiment of FIG. 5a, a control zone folder list 505 contains one or more control zone folders 507 with descriptive control zone folder names 509 for easy management. Alternatively, a corporate content creator 3090 may create a new control zone folder 507 by entering a new control zone folder name 509 in a new control zone folder name field 510 and selecting a create new control zone folder button 512.

Newly submitted or unassigned content or POIDs 3070 may appear in a miscellaneous content list 513. Data associated with each POID 3070 corresponds to data entered into the entry fields 410 on the content creator page 410. As FIG. 5a depicts, data associated with each POID 3070 falls within several categories representing several POID characteristics 514. These POID characteristics including a POID name 515, which corresponds to an internal field name 415, and a POID headline 520, which corresponds to the content creator page headline 420. The POID characteristics further may include a type 525, a POID start date 530, a POID end date 535, and a POID status 540, representing whether a POID 3070 is active in the content pool 3110 for use with one or more campaigns 3040.

From this corporate content manager home page 500, a corporate content creator 3090 may assign POIDs 3070 existing in the miscellaneous content list 513 to one or more control zone folders 507 in the control zone folder list 505. In the present embodiment, the corporate content manager home page 500 provides POID selection boxes 545 for specifying one or more POIDs 3070 upon which to act. Once a corporate content creator 3090 selects one or more POIDs 3070, a number of options exist. For example, a corporate content creator 3090 may select a campaigns button 550 to link a selected POID 3070 to one or more campaigns 3040, or a corporate content creator 3090 may select a POID copy button 555 for copying the POID 3070 into another folder 507. A delete selected POID button 560 allows for deletion of a selected POID 3070. Additionally, a POID move field 565 provides a drop down list reflecting the control zone folders 507 in the control zone folder list 505. This feature, along with a POID move completion button 567, enables a corporate content creator 3090 to move one or more selected POIDs 3070 to a particular control zone folder 507. Another optional administrative element present on the corporate content creator home page 500 is a new content type field 570 providing a drop down list of content types 525, such as but not limited to an offer, event, product or service. A create new content button 572 enables finalization of a content type 225 selection in the new content type field 570.

The example of FIG. 5a depicts a selected POID 3070 having “Ice cream sundaes” for a POID name 515. The corporate content creator 3090 has selected a control zone folder 507 entitled “Ice cream flavors” into which the selected POID 3070 will move. Additionally, the corporate content creator 3090 has elected to change the type 525 of that selected POID 3070 from an “event” to an “offer.” The corporate content creator 3090 may finalize these selections and then select one of the control zone folders 507 to access a corporate content manager folder view page 575. The corporate content manager folder view page 575 provides the control zone folder name 509 and a list of POIDs 3070 within that control zone folder 507. Here, each POID 3070 appears again with a POID name 515, a POID headline 520, a type 525, a POID start date 530, a POID end date 535, and a POID status 540. Several action buttons may exist here too including a campaigns button 550, a POID copy 555 button, a POID delete button 560, a move POID field 565 and a POID move completion button 567, a new content type field 570 and a create new content button 572 that act upon POIDs 3070 having associated, highlighted POID selection boxes 545.

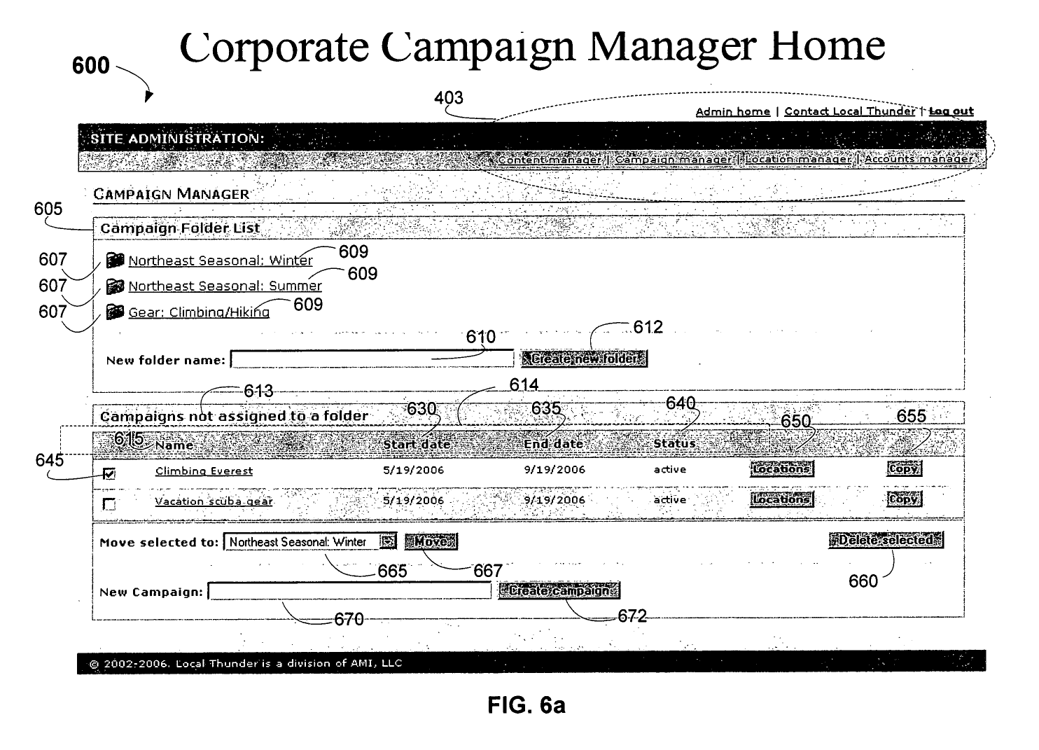

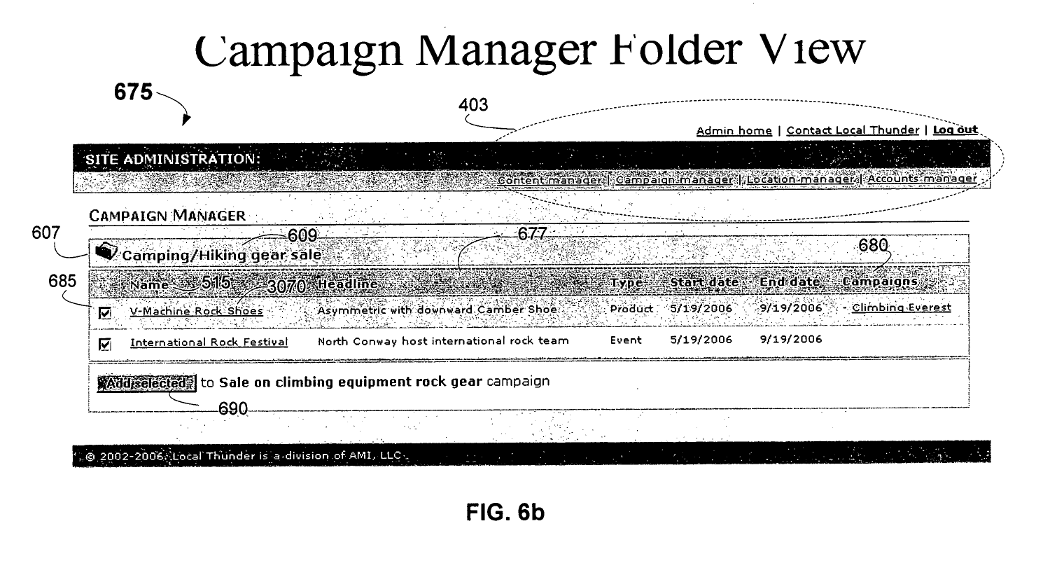

In addition to a corporate content manager home page 500 and folder view page 505, the present invention also provides a campaign manager home page 600 and campaign folder view page 675, exemplary embodiments of which are respectively depicted in FIGS. 6a and 6b. The campaign manager home page 600 and campaign folder view page 605 are shown by way of example only and both are adaptable to suit any number of conceivable formats for receiving information for creating a campaign 3040.

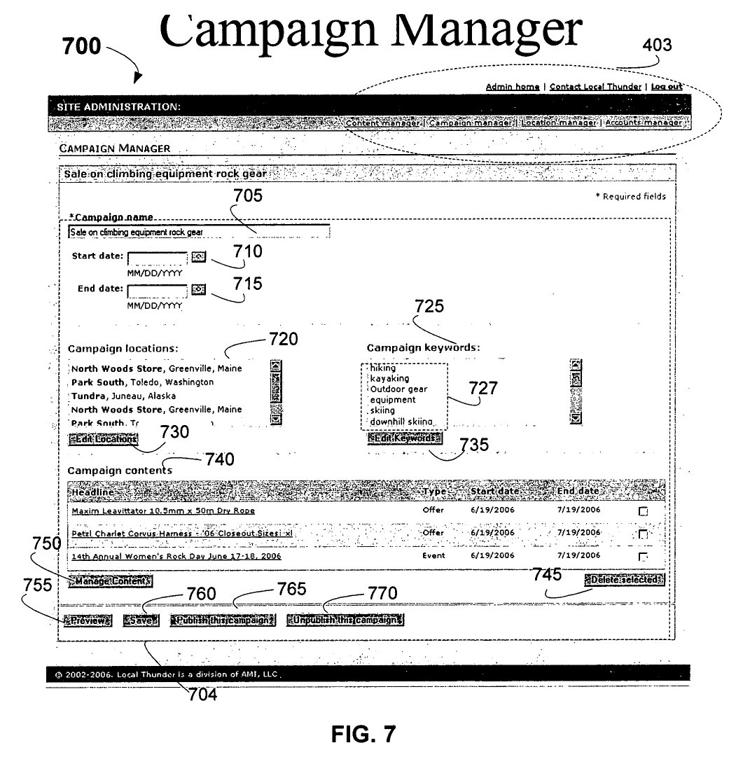

Much like the corporate content manager home page 500, the campaign manager home page 600 consists of typical webpage elements, such as for example, a top-level menu 403. A campaign folder list 605, having a recognizable folder nomenclature and appearance, comprises one or more campaign folders 607 representing existing campaigns 3040 each having a campaign folder name 609. A new campaign folder name field 610 and a corresponding create new campaign folder button 612 enable a campaign manager 3050 to create and accept a new campaign folder 607. In this exemplary embodiment to the campaign manager home page 600, the campaign folder list 605 exists beneath an unassigned campaigns list 613 comprising one or more campaigns 3040 that require assignment to one or more campaign folders 607. The data associated with each unassigned campaign 3040 corresponds to data entered into a campaign creation page 700 depicted in FIG. 7. As FIG. 6a depicts, data associated with each unassigned campaign 3040 falls within several categories representing several campaign parameters 614, including a campaign name 615, a campaign start date 630, a campaign end date 635, and a campaign status 640, which indicates whether a campaign 3040 is active or inactive as determined by the campaign manager 3050.

From the campaign manager home page 600, the campaign manager 3050 also may assign any campaign 3040 in the unassigned campaigns list 613 to a particular campaign folder 607 in the campaign folder list 605 or to any newly created campaign folder 607 created using the new campaign folder name field 610 and corresponding create new campaign folder button 612. In the present embodiment, the campaign manager home page 600 provides campaign selection fields 645 for specifying one or more campaigns 3040 upon which to act. Once a campaign manager 3050 highlights one or more campaign selection fields 645, a number of administrative options exist.

For example, a campaign manager 3050 may select a location button 650 to link a selected campaign 3040 to one or more locations 3062, or a corporate content creator 3090 may select a campaign copy button 655 for copying the POID 3070 into one or more additional campaign folders 607. A delete selected campaign button 660 allows for deletion of a selected campaign 3040. Additionally, a move campaign field 665 provides a drop down list reflecting the campaign folders 607 in the folder list 605. This feature, along with a campaign move completion button 667, enables a campaign manager 3050 to move one or more selected campaigns 3040 to a selected campaign folder 607. Another optional administrative elements present on the campaign manager home page 500 may include a new campaign field 670 and a corresponding create campaign button 672 for creating a new campaign 3040. The create campaign button 672 links to the campaign creation form 700 discussed below in reference to FIG. 7.

A campaign manager 3050 may click on any campaign folder 605 to view its contents. FIG. 6b is an exemplary embodiment of a campaign folder view page 675 depicting POIDs 3070 within a campaign folder 607 having “Camping/Hiking gear sale” for a campaign folder name 609. Each POID 3070 appears with associated campaign information 677, which may include a current campaign assignment 680 if one exists. In the exemplary embodiment of FIG. 6b, a POID 3070 having a POID name 515 “V-Machine Rock Shoes” is assigned to a campaign folder 609 having the campaign name 615 “Climbing Everest.” The campaign manager 3050 has highlighted a POID selection field 685 and thereby selected this POID 3070 to add to a specified campaign 3040 having the campaign name 615 “Sale on climbing equipment rock gear.” This exemplary campaign folder view page 675 further provides an add selected button 690 for associating any highlighted POIDs 3070 with the specified campaign 3040. A POID 3070 may associate not only with more than one control zone 3014, but also with one or more campaigns 3040.

In addition to administering campaigns 3040 using the campaign manager home page 600 and campaign folder view page 675, the campaign manager 3050 may create campaigns 3040 using the campaign creation page 700 as depicted in FIG. 7. FIG. 7 depicts an exemplary campaign creation page 700 providing elements including a top-level menu 403 and one or more campaign parameter fields 704 adapted to receive specific campaign parameters. For example, the campaign creation form 700 includes a campaign name field 705, a campaign start date field 710, and a campaign end date field 715. The campaign manager 3050 may specify on a campaign locations list 720 one or more locations 3062 with which a campaign 3040 will associate. Additionally, a campaign manager 3050 may specify on a campaign keywords list 725 one or more keywords 727 that will associate with the campaign 3040 under creation. The campaign locations list 720 and campaign keywords list 725 respectively have an edit locations button 730 and an edit keywords button 735 for confirming selected items.

This campaign creation page 700 also includes a campaigns contents list 740 from which a campaign manager 3050 may select POIDs 3070 for association with the campaign 3040 being created or modified. POIDs 3070 may be deleted or added to a campaign 3040 using a delete selected content button 745 and a manage content button 750. Additional action buttons may exist on the campaign creation page 700, including a preview button 755 for previewing contents and criteria of a campaign 3040, a save button 760 for saving modifications and selections; a publish this campaign button 765 for making the campaign 3040 available for public display, and an unpublish this campaign button 770, for withdrawing a campaign 3040 from public display. The campaign creation page 700 of FIG. 7. is shown by way of example only and is adaptable to suit any number of conceivable formats for receiving information for creating a campaign 3040.

Once the corporate manager 3090 approves POIDs 3070 and the campaign manager 3050 creates and publishes campaigns 3040, a local representative, such as the local content creator 3080, has a level of autonomy in selecting campaigns 3040 and associated POIDs 3070 for local display. The system and method of the present invention thus enable creating and managing operational content for specific locations 3062 using input provided and selected by local content creators 3080. This flexible permissions-based system and corresponding method allow marketing administrators to create and assign rights to organizational, regional and local store representatives for accessing various levels of the software 155 as deemed appropriate. Although the present invention provides a system and method for content creation and management, the software 155 is also adaptable for integrating with an organization's existing applications program interface (API). This feature allows the present invention to operate using existing applications for management of content and for tracking campaigns 3040. The present invention also is adapted for auditing efficacy of relevant marketing efforts, conversions and return on investment using click through tracking and reporting mechanisms.

Once campaigns 3040 are created and activated, external users, or customers, then may access these campaigns 3040 from their user terminals 107 in a number of ways. How a customer accesses an organization terminal 105 determines which campaigns 3040 appear on the locally relevant dynamic landing page 3010a. Campaign parameters, or rules 3052, established through the campaign creation page 700, campaign manager home page 600, and campaign folder view page 675, govern the dynamic construction of content within the context of single or multiple or aggregate locations 3062.

For example, the campaign rules 3052 include defining keywords 727 that are parsed from a referring search engine (e.g. Google™, Yahoo®, MSN®, etc) URLs. A Search Engine Marketing expert, or campaign manager 3050, may create a campaign 3040 targeting specific search terms such that links to a specific local landing page 3010a for a specific location 3062 or groups of locations 3060a appear in a search results list. Selecting a link to one of the search results for an organization using the system and method of the present invention will yield a dynamic landing page 3010a presenting locally relevant content, or POIDs 3070, that appear during specific date ranges at specific locations 3062. The search engine may function in conjunction with cookies on a user terminal's 107 web browser for determining a location 3062 of the user terminal for identifying one or more campaigns providing information locally relevant to the entered keywords 727. Additionally, the organic search engines index individual location landing pages 3010a higher in a results list because a richer context of services and goods offered makes the dynamic landing pages 3010a more relevant than others. Selecting a link to a campaign 3040 through a search engine results list will deploy a dynamic landing page 3010a with locally relevant content. A browser bar atop the redirected dynamic landing page 3010a retains the parsed keywords 727.

In addition to interacting with search engines, the present invention functions with any campaign-delivery method, including direct mailings of URLs and webpage banner advertisements. Additional campaign rules are flexible to allow the passing of externally defined campaign codes, membership data, campaign start dates 710, campaign end dates 715 and start times to display specific content, or POIDs 3070, via URL-based “get” methods, such as but not limited to a hypertext reference or banner advertisement. The system and method of the present invention also may deploy locally relevant POIDs 3070 via html form-based “post” methods. Again, cookies contained on a web browser of a user terminal 107 may identify a location 3062 for identifying one or more campaigns 3040, that provide locally relevant information.

E-Mail marketing experts may target emails to specific user terminals 107, for example, those belonging to organization members. Identifying targets may entail considering a number of parameters, including demographics, psychographics, and location, which thereby avoids rich media email spam filters, simplifies the “call to action” on the email itself and provides a more efficient click through to a rich media landing page 3010a. Even once a marketing email is deployed, a campaign manager 3050, local content creator 3080, and corporate content creator 3090 may continue to modify campaigns 3040 and POIDs 3070 to better react to market conditions. For example, if a consumer at a user terminal 107 clicks to a landing page 3010a on the third day of a campaign 3040, POIDs 3070 may appear differently than on the first day because of addition, removal, or editing of POIDs 3070 to account for sold-out goods and new cross-selling opportunities. The method and system of the present invention also enable deployment of dynamic “My Store” pages 3010c representing a customized and personalized marketing to consumers in reference to the store location 3062 nearest them.

The present invention thus provides better return on investment and manageability of search engine, email and banner ad campaigns with localized targeting by providing a single point deployment of rich content across a large organization to create a richer computer network, or world wide web (www), representation of individual locations 3062. This creates a better consumer experience that ensures that the local landing page 3010a that users arrive upon contains information that is both relevant to their expectations and is in synch with the organization's larger marketing goals.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A computer implemented method for creating and managing locally relevant dynamic content information for a regional, national or international organization and for selectively displaying the locally relevant information in response to a request from a user terminal connected to a computer network, comprising:
a) providing an organization terminal connected to the computer network wherein the organization terminal comprises a memory portion and a processor portion and wherein the memory portion contains therein a software portion executable by the processor, the memory portion further comprising:
i) a rule defining geographical boundaries within which to establish locally relevant dynamic content;
ii) one or more product object identifiers (POIDs) associated with the defined geographical boundaries of step i);
iii) defined control zones for placing the one or more POIDs within a graphical user interface for display at the user terminal;
iv) at least one hard coded template for placing the defined control zones and optional design elements on the graphical user interface; and
v) one or more campaigns wherein each campaign has one or more associated campaign rules governing population of the hard coded template in response to the request;
b) receiving the request at the organization terminal from the user terminal also connected to the computer network;
c) executing the software portion in response to the request; and
d) populating the at least one hard coded template with the one or more POIDs and the optional design elements within the defined control zones and according to the at least one campaign rule thereby creating a single point deployment of locally-relevant information at the user terminal.

2. The method of claim 1, wherein the memory portion is a server.

3. The method of claim 2, wherein the server further comprises a database for storing the at least one location definition, the defined control zones, the hard coded template, the one or more POIDs, optional design elements, and the one or more campaigns having at least one associated campaign rule.

4. The method of claim 1, wherein the optional design elements contain identification information for the at least one location.

5. The method of claim 4, wherein the identification information comprises a particular location address, an organization name or a map containing the particular location.

6. The method of claim 4, wherein the optional design elements comprise branding elements representative of the organization.

7. The method of claim 1, wherein the defined control zones are associated with the organization as a whole.

8. The method of claim 1, wherein the defined control zones are associated with the locally relevant geographical boundaries.

9. The method of claim 8 wherein the geographical boundaries comprise one or more organization locations.

10. The method of claim 1, wherein at least one defined control zone is associated with the organization as a whole and at least one defined control zone is associated with a locally relevant geographical boundary.

11. The method of claim 1, wherein the defined control zones are grouped by format and wherein an administrator may order and reorder defined control zones with a group without distorting layout on the graphical user interface.

12. The method of claim 1, further comprising assigning a campaign manager.

13. The method of claim 12, wherein the campaign manager creates the one or more campaign rules for each campaign.

14. The method of claim 13, wherein the one or more campaign rules define a campaign start date.

15. The method of claim 13, wherein the one or more campaign rules define a campaign end date.

16. The method of claim 13, wherein the one or more campaign rules assign each campaign to a hard coded template.

17. The method of claim 13, wherein the one or more campaign rules selectively assign each campaign to at least one location.

18. The method of claim 13, wherein the one or more campaign rules selectively assign each campaign to one or more pre-defined groups of locations.

19. The method of claim 18, wherein the one or more campaign rules exempt from the assignment one or more locations within the predefined groups.

20. The method of claim 13, wherein the one or more campaign rules associate each campaign with at least one of the defined control zones.

21. The method of claim 20, wherein the one or more campaign rules selectively assign one or more POIDs within the associated at least one defined control zone to the one or more associated campaigns.

22. The method of claim 21, further comprising mapping ranking exceptions for selectively assigned POIDs so that only a highest ranking product object identifier renders in a defined control zone on a graphical user interface at a user terminal.

23. The method of claim 21, wherein the one or more campaign rules optionally link one or more selectively assigned POIDs from a first defined control zone to one or more POIDS in any other defined control zones thereby creating an association at a data level for simultaneously displaying linked POIDs.

24. The method of claim 21, wherein the campaign manager optionally maps one or more selectively assigned POIDs in a first defined control zone to one or more POIDs in any other control zone so that the linked POIDs appear only separately, thereby preventing content conflicts.

25. The method of claim 1, wherein the one or more campaigns are search sensitive, and wherein the one or more campaigns include searchable keywords.

26. The method of claim 25, wherein a user at the user terminal may request locally relevant information about a product, object, service or event in a defined geographic location by entering query words into the referring search engine.

27. The method of claim 26, wherein the referring search engine identifies the one or more campaigns including searchable keywords that match the entered query words, and wherein the referring search engine provides a link for redirecting a user terminal directly to the one or more identified campaigns in response to the requested locally relevant information.

28. The method of claim 27, wherein the searchable keywords from the referring search engine remain in a URL browser bar on a redirected webpage displaying the one or more campaigns providing the locally relevant information.

29. The method of claim 28, further comprising recognizing cookies on a user terminal's web browser, wherein the cookies determine a location of the user terminal for identifying the one or more campaigns providing the locally relevant information.

30. The method of claim 28, wherein the searchable keywords include a location name that identifies the one or more campaigns providing the locally relevant information.

31. The method of claim 25, wherein a user at the user terminal may request locally relevant information about a product, object, service or event in a defined geographic location by entering the searchable keywords into an HTML-based form that automatically redirects a user terminal to the one or more campaigns in response to the requested locally relevant information.

32. The method of claim 31, further comprising recognizing cookies on a user terminal's web browser, wherein the cookies determine a location of the user terminal for identifying the one or more campaigns providing the locally relevant information.

33. The method of claim 1, wherein a user terminal is redirected from a get link to the one or more locally relevant campaigns.

34. The method of claim 33, wherein the get link is a hypertext reference.

35. The method of claim 33, wherein the get link is a banner advertisement.

36. The method of claim 33, further comprising recognizing cookies on a user terminal's web browser, wherein the cookies determine a relevant location and wherein keywords associated with the get link remain on a redirected webpage displaying the one or more locally relevant campaigns.

37. The method of claim 1, wherein the organization emails a link to the one or more campaigns to a user terminal.

38. The method of claim 37, further comprising recognizing cookies on a user terminal's web browser, wherein the cookies determine a relevant location and wherein a user terminal is automatically redirected to the locally relevant information.

39. The method of claim 1, further comprising selectively assigning the one or more POIDs to the defined control zones.

40. The method of claim 39, further comprising defining a POID type for each of the one or more POIDs.

41. The method of claim 39, wherein the POID type is one of a product, an offer, an event and a service.

42. The method of claim 39, wherein the one or more POIDs optionally include text for display at the user terminal.

43. The method of claim 39, wherein the one or more POIDs optionally include an associated image for display at the user terminal.

44. The method of claim 39, wherein the one or more POIDs optionally include an associated universal product code.

45. The method of claim 39, wherein the one or more POIDs optionally provide a link to a portable file.

46. The method of claim 39, wherein the one or more POIDs optionally provide a link to a multimedia file.

47. The method of claim 39, further comprising optionally providing a start date and an end date for displaying each of the one or more POIDs.

48-72. (canceled)

73. A system for providing a permissions-based platform for campaign creation and management that produces a store-based landing page representing a corporate entity at a local level by combining critical operational data with rich content describing specific offers, events, products and services for a store location, comprising:
a) a set of permissions that allows both corporate and local store representatives to access various levels of the system, wherein the representatives optionally are one of a campaign manager, a corporate content creator, and a local content creator;
b) at least one set of campaign rules created by the campaign manager;
c) a server connected to a computer network, wherein the server provides a database for storing the campaign rules and permissions;
d) product object identifier (POID) information linked to the store location and stored on the server for selective display in accordance with campaign rules; and
e) a corporate terminal in communication with the server,
i) wherein the terminal comprises a memory portion and a processor portion,
ii) wherein the memory portion has stored therein a series of commands executable by the processor for identifying and providing requested locally relevant POID information at a user terminal that also is in communication with the computer network,
iii) wherein the corporate terminal directly provides the locally relevant POID information in response to a search request from a referring search engine accessed by the user terminal,
iv) wherein the locally relevant POID information is linked to searchable keywords matching the search request;
v) wherein the locally relevant POID information displays at the user terminal on a landing page directly identified by the referring search engine, and
wherein the landing page includes a browser bar that retains the searchable keywords.
